(19) United States
(12) Patent Application Publication
(10) Pub. No.: US 2016/0282593 A1
(43) Pub. Date: Sep. 29, 2016

(54) Cell Phone Biological Microscope and Remote Biological Assay Method

(71) Applicant: Juan YAN, GUANGDONG (CN)

(72) Inventor: Juan YAN, GUANGDONG (CN)

(21) Appl. No.: 14/730,225

(22) Filed: Jun. 3, 2015

(30) Foreign Application Priority Data
Mar. 27, 2015 (CN) 201510142321.X

(51) Int. Cl. G02B 21/00; G02B 21/34; H04M 1/02; G02B 21/36; H04N 5/38; G02B 21/26; G02B 21/02

(52) U.S. Cl. CPC G02B 21/0008; G02B 21/26; G02B 21/34; G02B 21/02; G02B 21/362; H04N 5/38; H04M 1/026

(57) ABSTRACT

The invention has made public a cell phone biological microscope and a remote biological assay method. It includes lens cone. It also includes fixed glass slide component and active glass slide component; fixed glass slide component includes fixed glass slide stand and fixed glass slide; active glass slide component includes fixed support, active glass slide stand and active glass slide, where one end of fixed support is connected to the outer wall of lens cone, and the other end of the fixed support is flexibly connected to the said active glass slide stand. The invention has the benefits as follows: it provides a portable and user-friendly cell phone biological microscope and a remote biological assay method using this biological microscope. This cell phone biological microscope is equipped with an adjustable glass slide system to achieve the remote assay of biological sample.

### BACKGROUND OF THE INVENTION

The invention involves a microscope, in particular, cell phone biological microscope and remote biological assay method.

Biological assay is generally carried out in laboratory using medical or biological microscope, where the glass slide treated assay item is placed under biological microscope, subject to manual or computer analytical statistics. Without laboratory, it would be difficult to carry out the biological assay of blood, water, plant solution or chemical solution for parasitic or bacterial testing. The existing biological microscope is too bulky and heavy to carry around, so it is not convenient to carry out the assay, particularly outdoors or in the field. As people have increasing demands for life quality and outdoor exploration, a portable and user-friendly microscopic analysis device has become a necessity of life.

### BRIEF SUMMARY OF THE INVENTION

The intention is to overcome the existing technical problems, and to provide a portable and user-friendly cell phone biological microscope and a remote biological assay method using this biological microscope. This cell phone biological microscope is equipped with an adjustable glass slide system to achieve the remote assay of biological sample.

On one hand, the invention provides a cell phone biological microscope including lens cone. The said lens cone is installed with objective lens component and eye lens component in the axial direction on both ends respectively. It has the improvements as follows: the said cell phone biological microscope also includes fixed glass slide component and active glass slide component; the said fixed glass slide component includes fixed glass slide stand and fixed glass slide, where the said fixed glass slide is fixed on one end of the said lens cone installed with the said objective lens component via the said fixed glass slide stand; the said active glass slide component includes fixed support, active glass slide stand and active glass slide, where one end of the said fixed support is connected to the outer wall of the said lens cone, and the other end of the fixed support is flexibly connected to the said active glass slide stand; when the said active glass slide moves on the said fixed support along with the said active glass slide stand, the said active glass slide can be closely attached to or separated from the said fixed glass slide.

In the above-mentioned structure, the said active glass slide stand is equipped with close-spaced structure, and the said active glass slide and the said fixed glass slide are fixed together via the said close-spaced structure after being closely attached.

In the above-mentioned structure, the said flexible connection is rotating connection, the said active glass slide stand is connected to the said fixed support via the rotation shaft, and the said active glass slide stand can rotate around the said rotation shaft.

In the above-mentioned structure, the said close-spaced structure refers to the interactive magnet A and magnet B installed on the said active glass slide stand and the said lens cone respectively, and when the said active glass slide is closely attached to the said fixed glass slide, the mutual adsorption of the said magnet A and magnet B fixes the said active glass slide stand on the said fixed glass slide stand.

In the above-mentioned structure, the said active glass slide stand is installed with light-source lens coaxial with the said active glass slide.

In the above-mentioned structure, one end of the said lens cone installed with the said eye lens component is equipped with an extended mount, and the said extended mount fixes the said cell phone biological microscope at the cell phone lens via the adaptive fixed cassette.

In the above-mentioned structure, the said objective lens component includes glued lens A, glued lens B, objective lens aperture and objective lens ring, and the said eye lens component includes glued lens C, glued lens D, eye lens aperture and eye lens ring; the said objective lens ring, glued lens A, objective lens aperture, glued lens B, eye lens ring, glued lens C, eye lens aperture and glued lens D are installed inside the said lens cone in sequence along the axial direction of the said lens cone.

In the above-mentioned structure, the said fixed support includes the annulus and the supporting bar connected to the said annulus; the said annulus is installed on the outer wall of the said lens cone; one end of the said fixed glass slide stand is tied to the said lens cone via the screw thread, and the other end of the said fixed glass slide stand is installed with the said fixed glass slide; the optical focus of the said objective lens component is located on the said fixed glass slide.

On the other hand, the invention provides the remote biological assay method using the said cell phone biological microscope. The assay sample information is from the said cell phone biological microscope. This method includes sample information generation via the said cell phone biological microscope;

The said cell phone biological microscope includes lens cone. The said lens cone is installed with objective lens component and eye lens component in the axial direction on both ends respectively. It also includes fixed glass slide component and active glass slide component; the said fixed glass slide component includes fixed glass slide stand and fixed glass slide, where the said fixed glass slide is fixed on one end of the said lens cone installed with the said objective lens component via the said fixed glass slide stand; the said active glass slide component includes fixed support, active glass slide stand and active glass slide, where one end of the said fixed support is connected to the outer wall of the said lens cone, and the other end of the fixed support is flexibly connected to the said active glass slide stand; when the said active glass slide moves on the said fixed support along with the said active glass slide stand, the said active glass slide can be closely attached to or separated from the said fixed glass slide; one end of the said lens cone installed with the said eye lens component is equipped with an extended mount, and the said extended mount fixes the said cell phone biological microscope at the cell phone lens via the adaptive fixed cassette.

This method also includes sending of the said sample information via the mobile terminal connected to the said cell phone biological microscope and remote analysis of the said sample information.

The process of sample information generation using the said cell phone biological microscope is as follows: 1. Rotate the active glass slide stand to separate the active glass slide from the fixed glass slide; 2. Place the sample for assay on the active glass slide, rotate the active glass slide until the active glass slide is attached to the fixed glass slide, and then press to obtain the assay sample.

Due to the butting of the eye lens of cell phone biological microscope with the cell phone lens to reflect the obtained sample in the cell phone in the picture form, the sample can be analyzed through the display on the cell phone, or the sample information can be transferred to the remote receiving terminal via the mobile terminal to achieve the remote analysis.

The invention has the benefits as follows: first, the cell phone biological microscope indicated in the invention is equipped with active glass slide and fixed glass slide, convenient to carry around and clean the glass slides, able to achieve the analysis of different samples without lots of glass slides.

Second, cell phone biological microscope indicated in the invention allows the eye lens to butt with the cell phone lens to reflect the sample information on the cell phone more objectively and clearly, and can take full advantage of powerful data processing, analysis and transfer functions of mobile terminal to further achieve the remote assay of biological sample.

Third, the lens are used to import external light source to achieve the coaxial light source function. The assay item is located between the lens system and the light-source lens, so that the cell phone biological microscope indicated in the invention can work under different lighting conditions, which can use sunlight as the light source in the daytime, and use fire or other lights as the light source in the evening.

### BRIEF DESCRIPTION OF THE DRAWINGS

FIG. 1 is the front view of cell phone biological microscope indicated in the invention.

FIG. 2 is the profile of A-A in Fig.1.

FIG. 3 is the disengaged status diagram of active glass slide and fixed glass slide of cell phone biological microscope indicated in the invention.

FIG. 4 is the attachment status diagram of active glass slide and fixed glass slide of cell phone biological microscope indicated in the invention.

Items shown in the figure: 1. Lens, 2. Fixed glass slide stand, 3. Fixed support, 4. Active glass slide stand, 5. Fixed glass slide, 6. Active glass slide, 7. Light-source lens, 8. Magnet A, 9. Magnet B, 10. Rotation shaft, 11. Glued lens A, 12. Glued lens B, 13. Glued lens C, 14. Glued lens D, 15. Extended mount, 16. Eye lens aperture, 17. Eye lens ring, 18. Objective lens aperture, 19. Objective lens ring.

### DETAILED DESCRIPTION OF THE INVENTION

The invention will be further described in combination with the figures and the specific implementation modes below:

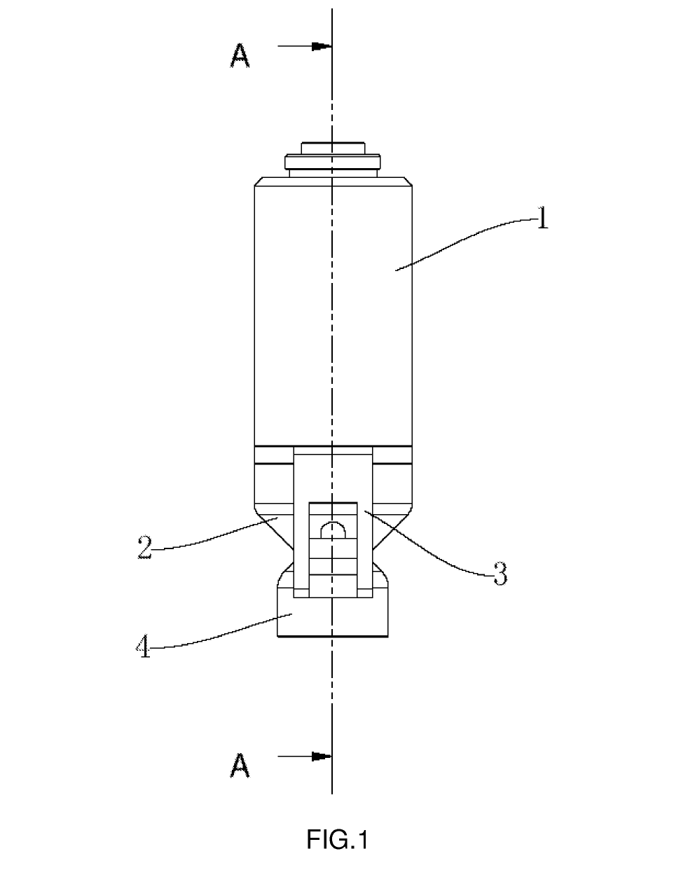

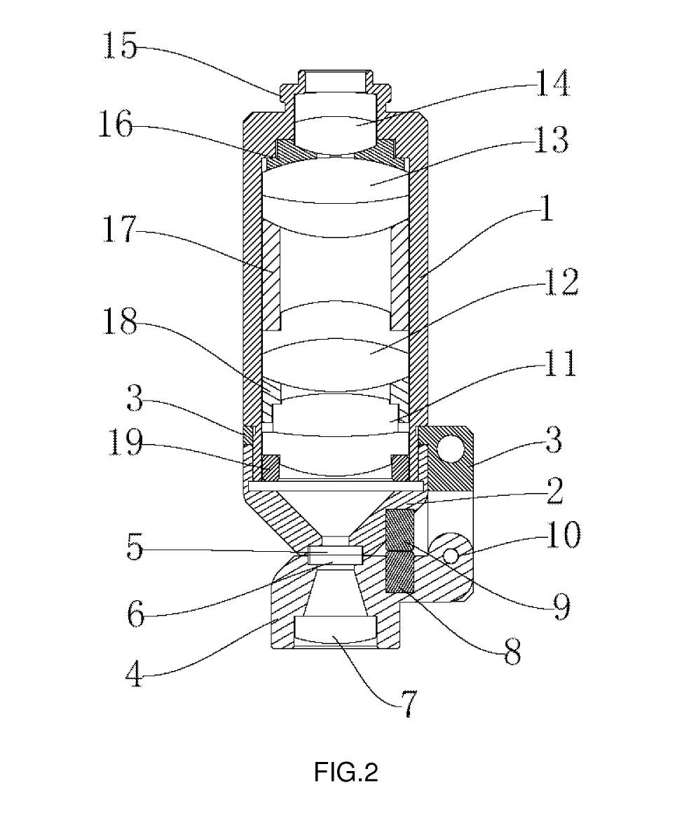

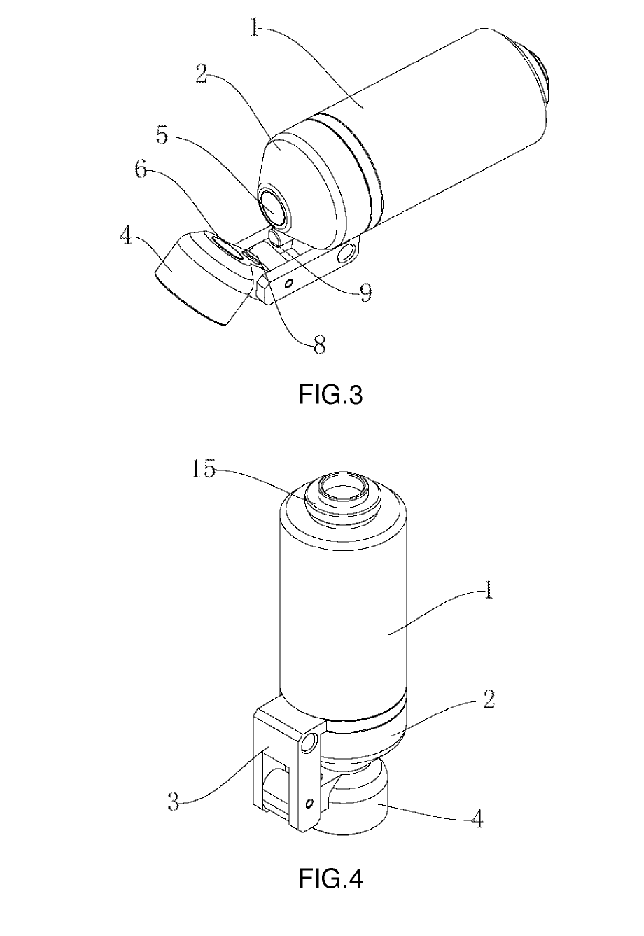

As shown in FIG. 1 through FIG. 4, the invention indicates a cell phone biological microscope including lens cone (1). The lens cone (1) is installed with objective lens component and eye lens component in the axial direction on both ends respectively. The cell phone biological microscope also includes fixed glass slide component and active glass slide component; the fixed glass slide component includes fixed glass slide stand (2) and fixed glass slide (5), where the fixed glass slide (5) is fixed on one end of the lens cone (1) installed with the said objective lens component via the said fixed glass slide stand (2); the active glass slide component includes fixed support (3), active glass slide stand (4) and active glass slide (6), where one end of the fixed support (3) is connected to the outer wall of the lens cone (1), and the other end of the fixed support (3) is flexibly connected to the active glass slide stand (4); when the active glass slide (6) moves on the fixed support (3) along with the active glass slide stand (4), the active glass slide (6) can be closely attached to or separated from the fixed glass slide (5).

Further, the active glass slide stand (4) is equipped with close-spaced structure, and the active glass slide (6) and the fixed glass slide (5) are fixed together via the said close-spaced structure after being closely attached.

Further, the said flexible connection is rotating connection, the active glass slide stand (4) is connected to the fixed support (3) via the rotation shaft (10), and the active glass slide stand (4) can rotate around the rotation shaft (10).

Further, the said close-spaced structure refers to the interactive magnet A (8) and magnet B (9) installed on the active glass slide stand (4) and the lens cone (1) respectively, and when the active glass slide (6) is closely attached to the fixed glass slide (5), the mutual adsorption of the magnet A (8) and magnet B (9) fixes the active glass slide stand (4) on the fixed glass slide stand (2).

Further, the active glass slide stand (4) is installed with light-source lens (7) coaxial with the active glass slide (6).

Further, one end of the lens cone (1) installed with the said eye lens component is equipped with an extended mount (15), and the extended mount (15) fixes the cell phone biological microscope at the cell phone lens via the adaptive fixed cassette.

Further, the said objective lens component includes glued lens A (11), glued lens B (12), objective lens aperture (18) and objective lens ring (19), and the said eye lens component includes glued lens C (13), glued lens D (14), eye lens aperture (16) and eye lens ring (17); the said objective lens ring (19), glued lens A (11), objective lens aperture (18), glued lens B (12), eye lens ring (17), glued lens C (13), eye lens aperture (16) and glued lens D (14) are installed inside the said lens cone in sequence along the axial direction of the lens cone (1).

Further, the fixed support (3) includes the annulus and the supporting bar connected to the said annulus; the said annulus is installed on the outer wall of the lens cone (1); one end of the fixed glass slide stand (2) is tied to the lens cone (1) via the screw thread, and optimally, when the fixed glass slide stand (2) is tied to the lens cone (1), the said annulus is pressed and fixed on the lens cone (1); the other end of the fixed glass slide stand (2) is installed with the fixed glass slide (5); the optical focus of the said objective lens component is located on the fixed glass slide (5).

This is a remote biological assay method corresponding to the said cell phone biological microscope. The assay sample information is from the said cell phone biological microscope. This method includes sample information generation using the said cell phone biological microscope;

The said cell phone biological microscope includes lens cone (1). The lens cone (1) is installed with objective lens component and eye lens component in the axial direction on both ends respectively. The cell phone biological microscope also includes fixed glass slide component and active glass slide component; the fixed glass slide component includes fixed glass slide stand (2) and fixed glass slide (5), where the fixed glass slide (5) is fixed on one end of the lens cone (1) installed with the said objective lens component via the said fixed glass slide stand (2); the active glass slide component includes fixed support (3), active glass slide stand (4) and active glass slide (6), where one end of the fixed support (3) is connected to the outer wall of the lens cone (1), and the other end of the fixed support (3) is flexibly connected to the active glass slide stand (4); One end of the lens cone (1) installed with the said eye lens component is equipped with an extended mount (15), and the extended mount (15) fixes the cell phone biological microscope at the cell phone lens via the adaptive fixed cassette.

This method also includes sending of the said sample information via the mobile terminal connected to the said cell phone biological microscope and remote analysis of the said sample information.

The process of sample information generation using the said cell phone biological microscope is as follows: 1. Rotate the active glass slide stand to separate the active glass slide from the fixed glass slide; 2. Place the sample for assay on the active glass slide, rotate the active glass slide until the active glass slide is attached to the fixed glass slide, and then press to obtain the assay sample.

Due to the butting of the eye lens of cell phone biological microscope with the cell phone lens to reflect the obtained sample in the cell phone in the picture form, the sample can be analyzed through the display on the cell phone, or the sample information can be transferred to the remote receiving terminal via the mobile terminal to achieve the remote analysis.

The above is only the preferable implementation case of the invention, which is not the restriction of the invention. Any version and revision will be allowed within the technological thought scope of the invention. Any polishing, revision or equivalent replacement by any ordinary technical staff in the field based on the above descriptions will belong to the scope of protection of the invention.

What is claimed is:

1. This is a cell phone biological microscope including lens cone. The said lens cone is installed with objective lens component and eye lens component in axial direction on both ends respectively. It has the characteristics as follows: the said cell phone biological microscope also includes fixed glass slide component and active glass slide component; the said fixed glass slide component includes fixed glass slide stand and fixed glass slide, where the said fixed glass slide is fixed on one end of the said lens cone installed with the said objective lens component via the said fixed glass slide stand; the said active glass slide component includes fixed support, active glass slide stand and active glass slide, where one end of the said fixed support is connected to the outer wall of the said lens cone, and the other end of the fixed support is flexibly connected to the said active glass slide stand; when the said active glass slide moves on the said fixed support along with the said active glass slide stand, the said active glass slide can be closely attached to or separated from the said fixed glass slide.

2. The cell phone biological microscope, as described in claim 1, has the characteristics as follows: the said active glass slide stand is equipped with close-spaced structure, and the said active glass slide and the said fixed glass slide are fixed together via the said close-spaced structure after being closely attached.

3. The cell phone biological microscope, as described in claim 1, has the characteristics as follows: the said flexible connection is rotating connection, the said active glass slide stand is connected to the said fixed support via the rotation shaft, and the said active glass slide stand can rotate around the said rotation shaft.

4. The cell phone biological microscope, as described in claim 2, has the characteristics as follows: the said flexible connection is rotating connection, the said active glass slide stand is connected to the said fixed support via the rotation shaft, and the said active glass slide stand can rotate around the said rotation shaft.

5. The cell phone biological microscope, as described in claim 3, has the characteristics as follows: the said close-spaced structure refers to the interactive magnet A and magnet B installed on the said active glass slide stand and the said lens cone respectively, and when the said active glass slide is closely attached to the said fixed glass slide, the mutual adsorption of the said magnet A and magnet B fixes the said active glass slide stand on the said fixed glass slide stand.

6. The cell phone biological microscope, as described in claim 3, has the characteristics as follows: the said active glass slide stand is installed with light-source lens coaxial with the said active glass slide.

7. The cell phone biological microscope, as described in claim 4, has the characteristics as follows: the said close-spaced structure refers to the interactive magnet A and magnet B installed on the said active glass slide stand and the said lens cone respectively, and when the said active glass slide is closely attached to the said fixed glass slide, the mutual adsorption of the said magnet A and magnet B fixes the said active glass slide stand on the said fixed glass slide stand.

8. The cell phone biological microscope, as described in claim 4, has the characteristics as follows: the said active glass slide stand is installed with light-source lens coaxial with the said active glass slide.

9. The cell phone biological microscope, as described in claim 1, has the characteristics as follows: one end of the said lens cone installed with the said eye lens component is equipped with an extended mount, and the said extended mount fixes the said cell phone biological microscope at the cell phone lens via the adaptive fixed cassette.

10. The cell phone biological microscope, as described in claim 1, has the characteristics as follows: the said objective lens component includes glued lens A, glued lens B, objective lens aperture and objective lens ring, and the said eye lens component includes glued lens C, glued lens D, eye lens aperture and eye lens ring; the said objective lens ring, glued lens A, objective lens aperture, glued lens B, eye lens ring, glued lens C, eye lens aperture and glued lens D are installed inside the said lens cone in sequence along the axial direction of the said lens cone.

11. The cell phone biological microscope, as described in claim 10, has the characteristics as follows: the said fixed support includes the annulus and the supporting bar connected to the annulus; the said annulus is installed on the outer wall of the said lens cone; one end of the said fixed glass slide stand is tied to the said lens cone via the screw thread, and the other end of the said fixed glass slide stand is installed with the said fixed glass slide; the optical focus of the said objective lens component is located on the said fixed glass slide.

12. This is a remote biological assay method. The assay sample information is from the cell phone biological microscope described in claim 1. This method includes sample collection and sample information generation via the said cell phone biological microscope;
The said cell phone biological microscope includes lens cone. The said lens cone is installed with objective lens component and eye lens component in axial direction on both ends respectively. It also includes fixed glass slide component and active glass slide component; the said fixed glass slide component includes fixed glass slide stand and fixed glass slide, where the said fixed glass slide is fixed on one end of the said lens cone installed with the said objective lens component via the said fixed glass slide stand; the said active glass slide component includes fixed support, active glass slide stand and active glass slide, where one end of the said fixed support is connected to the outer wall of the said lens cone, and the other end of the fixed support is flexibly connected to the said active glass slide stand; when the said active glass slide moves on the said fixed support along with the said active glass slide stand, the said active glass slide can be closely attached to or separated from the said fixed glass slide;
This method also includes sending of the said sample information via the mobile terminal connected to the said cell phone biological microscope and remote analysis of the said sample information.

13. The remote biological assay method, as described in claim 12, has the characteristics as follows: one end of the said lens cone installed with the said eye lens component is equipped with an extended mount, and the said extended mount fixes the said cell phone biological microscope at the cell phone lens via the adaptive fixed cassette.
